(19) United States
(12) Patent Application Publication
(10) Pub. No.: US 2022/0065714 A1
(43) Pub. Date: Mar. 3, 2022

(54) FORCE DETECTION DEVICE, FORCE DETECTION SYSTEM, AND MANUFACTURING METHOD OF FORCE DETECTION DEVICE

(71) Applicant: YOKOGAWA ELECTRIC CORPORATION, Tokyo (JP)

(72) Inventor: Tomohito Nohno, Tokyo (JP)

(73) Assignee: YOKOGAWA ELECTRIC CORPORATION, Tokyo (JP)

(21) Appl. No.: 17/406,593

(22) Filed: Aug. 19, 2021

(30) Foreign Application Priority Data
Aug. 28, 2020 (JP) 2020-144899

(51) Int. Cl. G01L 1/14; G01L 1/18; G01L 5/00; B25J 9/16

(52) U.S. Cl. CPC G01L 1/146; B25J 9/1633; G01L 5/0061; G01L 1/18

(57) ABSTRACT

A force detection device includes: a substrate; a plurality of force sensors formed on the substrate; and a fixing member that fixes the substrate. The fixing member fixes the substrate in a folded state. The fixing member fixes the substrate in a randomly folded state or a regularly folded state. The plurality of force sensors is formed on the substrate by being distributed two-dimensionally thereon. The substrate is a flexible substrate. The fixing member is a resin.

### BACKGROUND

### Technical Field

The present invention generally relates to a force detection device, a force detection system, and a manufacturing method of a force detection device.

### Related Art

Conventionally, a force sensor is known that can detect, for example, touch. As a usage of the force sensor, a usage is known of, for example, equipping the force sensor to a hand of a robot and causing the hand of the robot to detect touch.

Individual force sensors are normally able to detect forces in one direction. However, it may be sought of the force sensor to detect a force in a multiaxial direction.

For example, patent literature 1 discloses a touch sensor device that can detect a force. The touch sensor device is provided with a plurality of touch sensor units, and each touch sensor unit is provided with four touch sensors that are arranged at 90-degree intervals on a plane. The touch sensor has a raised portion formed by being bent. Such a structure enables the touch sensor device according to patent literature 1 to detect a force in a multiaxial direction.

### PATENT LITERATURE

Patent Literature 1: JP 2008-26178 A

The art taught in patent literature 1 is costly to manufacture because it has a complex structure formed by bending.

### SUMMARY

One or more embodiments provide a force detection device, a force detection system, and a manufacturing method of a force detection device whereby a force in a triaxial direction can be detected by a simple structure.

A force detection device according to one or more embodiments includes a substrate, a plurality of force sensors formed on the substrate, and a fixing member that fixes the substrate. The fixing member fixes the substrate in a folded state. According to such a force detection device, a force in a triaxial direction can be detected by a simple structure.

In a force detection device according to one or more embodiments, the fixing member may fix the substrate in a randomly folded state. In this manner, by fixing the substrate in a randomly folded state, the plurality of force sensors formed on the substrate can be oriented in a plurality of three-dimensional directions.

In a force detection device according to one or more embodiments, the fixing member may fix the substrate in a regularly folded state. In this manner, by fixing the substrate in a regularly folded state, the plurality of force sensors formed on the substrate can be intentionally oriented in a plurality of three-dimensional directions.

In a force detection device according to one or more embodiments, the plurality of force sensors may be formed on the substrate by being distributed two-dimensionally thereon. In this manner, by the plurality of force sensors being formed on the substrate by being distributed two-dimensionally thereon, the force detection device can detect a detailed distribution of a force applied to the force detection device.

In a force detection device according to one or more embodiments, the substrate may be a flexible substrate. In this manner, by the substrate being a flexible substrate, the force detection device can have flexibility. This can prevent the substrate from breaking when the force detection device greatly deforms.

In a force detection device according to one or more embodiments, the fixing member may be a resin. In this manner, by the fixing member being a resin, the force detection device can have flexibility.

A force detection system according to one or more embodiments includes the force detection device according to one or more embodiments and a computation device. The computation device includes a storage unit that stores a calibration value calculated based on a force applied in advance to the force detection device and a control unit that, based on the calibration value, calculates a force applied to the force detection device. In this manner, by the control unit calculating the force applied to the force detection device based on the calibration value stored in the storage unit, the force detection system can calculate the force applied to the force detection device based on the calibration value calculated according to the force detection device.

A manufacturing method of a force detection device according to one or more embodiments includes a step of forming a plurality of force sensors on a substrate, a step of folding the substrate, and a step of fixing the substrate in a folded state by a fixing member. According to such a manufacturing method of a force detection device, a force detection device that can detect a force in a triaxial direction by a simple structure can be easily manufactured.

### Effects of Invention

According to one or more embodiments, a force detection device, a force detection system, and a manufacturing method of a force detection device whereby a force in a triaxial direction can be detected by a simple structure can be provided.

### BRIEF DESCRIPTION OF THE DRAWINGS

FIG. 1 is a diagram illustrating a schematic configuration of a force detection system according to one or more embodiments.

FIG. 2 is a top view illustrating a schematic configuration of a force detection device according to one or more embodiments.

FIG. 3 is a sectional view illustrating the schematic configuration of the force detection device according to one or more embodiments.

FIG. 4 is a top view of a substrate in a state prior to folding.

FIG. 5 is a diagram illustrating one example of a force for calibration being applied to the force detection device.

FIG. 6 is a diagram illustrating one example of the force detection device measuring a force that is being applied.

FIG. 7 is a flowchart illustrating one example of a manufacturing process of the force detection device.

### DETAILED DESCRIPTION

Embodiments of the present invention will be described below with reference to the drawings.

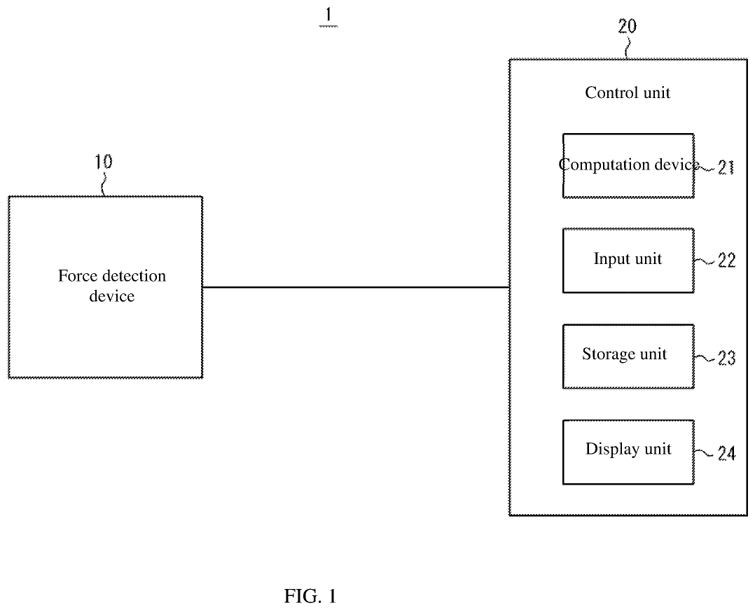

FIG. 1 is a diagram illustrating a schematic configuration of a force detection system 1 according to one or more embodiments. The force detection system 1 includes a force detection device 10 and a computation device 20.

The force detection device 10 is a device that can detect touch. That is, the force detection device 10 can detect a force applied to the force detection device 10. The force detection device 10 can detect a force in a triaxial direction. The force detection device 10 can detect a magnitude, orientation, and distribution of the force in the triaxial direction. The force detection device 10 is electrically connected to the computation device 20.

The computation device 20 calculates, based on a force applied to the force detection device 10 in advance, a calibration value for calibrating the force detection device 10. The computation device 20 stores the calculated calibration value. Upon storing the calibration value, the computation device 20 calibrates, based on the stored calibration value, a value detected by the force detection device 10 and calculates the force applied to the force detection device 10.

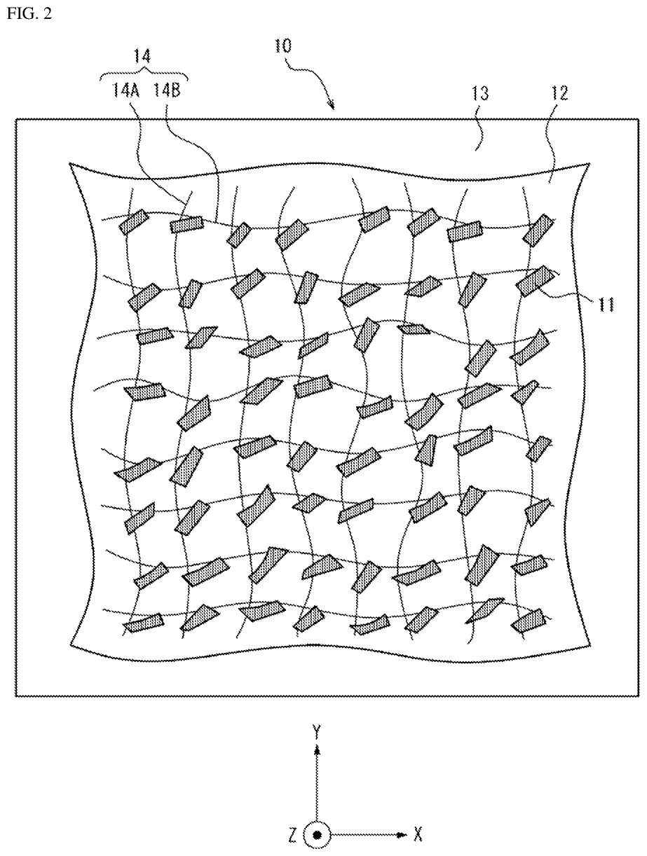

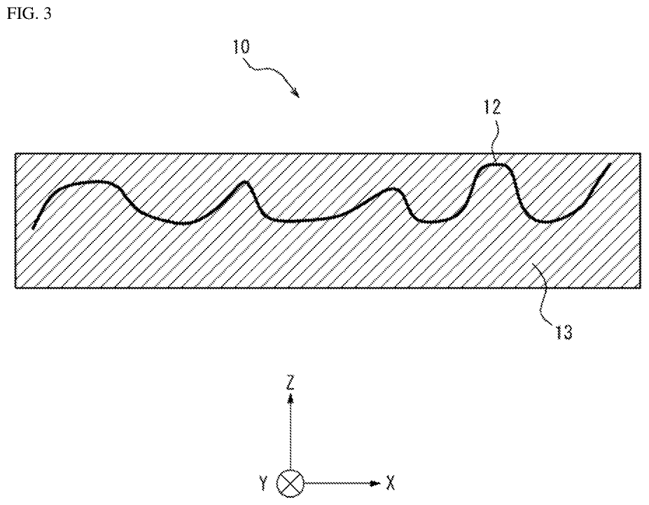

A schematic configuration of the force detection device 10 is described with reference to FIG. 2 and FIG. 3. FIG. 2 is a top view illustrating the schematic configuration of the force detection device 10 according to one or more embodiments. FIG. 3 is a sectional view illustrating the schematic configuration of the force detection device 10 according to one or more embodiments.

As illustrated in FIG. 2, the force detection device 10 includes a plurality of force sensors 11, a substrate 12, a fixing member 13, and wiring 14. In the example illustrated in FIG. 2, the wiring 14 includes vertical wiring 14A and horizontal wiring 14B. Note that in the sectional view of the force detection device 10 illustrated in FIG. 3, illustration of the force sensors 11 and the wiring 14 is omitted.

The force sensor 11 is a sensor that can detect a force applied to the force sensor 11. The force sensor 11 can detect a force in at least one direction. The force sensor 11 may be, for example, a piezoresistive strain sensor or a capacitive strain sensor. The force sensor 11 is composed of a flexible material. The force sensor 11 has flexibility and is deformable. When the force detection device 10 is equipped to, for example, a hand of a robot, the force sensor 11 can function as a touch sensor.

As illustrated in FIG. 2, the plurality of force sensors 11 is formed on the substrate 12. The plurality of force sensors 11 may be formed on the substrate 12 by being arranged in, for example, a matrix. However, arrangement of the plurality of force sensors 11 is not limited to arrangement in a matrix, and the plurality of force sensors 11 may be formed on the substrate 12 in any arrangement.

The substrate 12 is a tabular substrate that can be deformed by, for example, being folded. The substrate 12 is a flexible substrate. The substrate 12 being flexible enables easy folding. Moreover, the substrate 12 being flexible can prevent the substrate 12 from breaking when the force detection device 10 greatly deforms. The substrate 12 is thin. The substrate 12 being thin enables the force detection device 10 to be reduced in size. The substrate 12 may be a film of, for example, plastic or rubber.

The substrate 12 is originally tabular but is fixed in a folded state by the fixing member 13. The substrate 12 being fixed in the folded state by the fixing member 13 is schematically illustrated in FIG. 2 and FIG. 3.

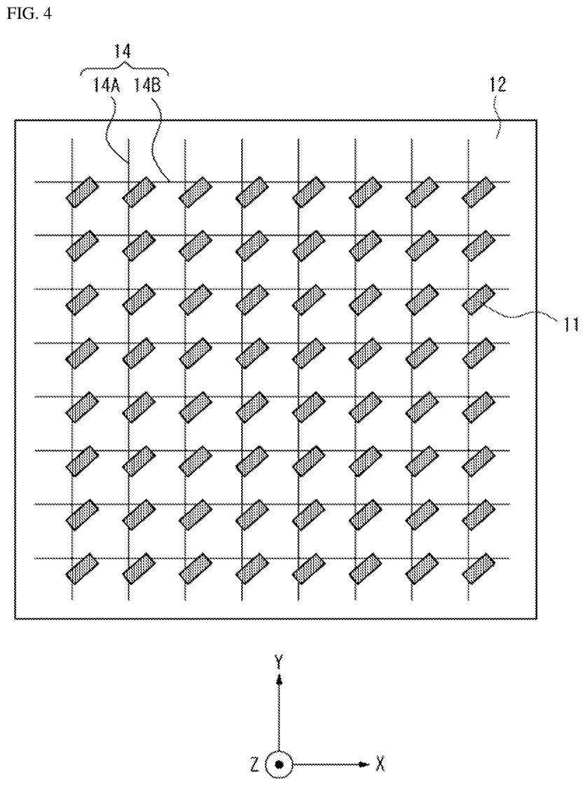

FIG. 4 is a diagram illustrating the substrate 12 in a state prior to folding. As illustrated in FIG. 4, the plurality of force sensors 11 is formed on the substrate 12 by being distributed two-dimensionally thereon. The plurality of force sensors 11 may be arranged regularly—for example, in a matrix—on the substrate 12 in the state prior to folding. By a tabular substrate 12 such as that illustrated in FIG. 4 being fixed in a folded state, the substrate 12 adopts, as one example, a shape such as that illustrated in the top view of FIG. 2 and the sectional view of FIG. 3.

In the present embodiment, the substrate 12 being folded means that the substrate 12 is deformed from being planar to having an uneven shape. The uneven shape of the substrate 12 may be formed by, for example, folds or wrinkles.

As illustrated in FIG. 2 and FIG. 3, because the fixing member 13 fixes the substrate 12 in the folded state, the plurality of force sensors 11 formed on the substrate 12 is oriented not in a uniform direction but in a plurality of three-dimensional directions. Therefore, the plurality of force sensors 11 can detect forces in a plurality of three-dimensional directions even if individual force sensors 11 can only detect forces in one direction. That is, the plurality of force sensors 11 can detect a force in a triaxial direction.

Furthermore, prior to being folded, the substrate 12 is a tabular substrate such as that illustrated in FIG. 4. As illustrated in FIG. 4, the plurality of force sensors 11 may be formed on the substrate 12 that is not yet folded by being arranged regularly thereon. Forming the force sensors 11 on the substrate 12 in this manner by arranging them regularly thereon is possible by a simple process. For example, although it is conceivable to enable detection of forces in a plurality of directions by forming a plurality of force sensors on a substrate by orienting each in a plurality of three-dimensional directions, such a manufacturing method involves a complex process and therefore raises manufacturing costs. In contrast, a manufacturing method, such as that of the force detection device 10 according to the present embodiment, of forming the plurality of force sensors 11 on the substrate 12 that is not yet folded by arranging them regularly thereon in a one-dimensional or two-dimensional manner involves a simple process and can therefore lower manufacturing costs.

The substrate 12 may be fixed by the fixing member 13 in a state of being randomly folded or be fixed by the fixing member 13 in a state of being regularly folded.

The fixing member 13 fixes the substrate 12 in the folded state. The fixing member 13 is composed of a flexible material. The fixing member 13 may be, for example, a resin. The fixing member 13 may be, for example, a silicone resin, an acrylic resin, or a urethane resin. The substrate 12 may be placed inside the fixing member 13 in a folded state and thereafter be fixed by the fixing member 13 or be folded upon being placed in the fixing member 13 and thereafter be fixed by the fixing member 13.

The wiring 14 is wiring for extracting a signal output by the force sensor 11. The wiring 14 includes a conductor for transmitting an electrical signal. As illustrated in FIG. 2, for each force sensor 11, one end of the force sensor 11 is electrically connected to the vertical wiring 14A, and another end of the force sensor 11 is electrically connected to the horizontal wiring 14B.

In the example illustrated in FIG. 2, the wiring 14 connects the plurality of force sensors 11, arranged two-dimensionally on the substrate 12, in a matrix. The force detection device 10 can, by connecting the plurality of force sensors 11 in a matrix by the wiring 14 in this manner, decrease a wire count of the wiring 14 necessary to extract the signals output by the plurality of force sensors 11.

Next, a schematic configuration of the computation device 20 is described, once again with reference to FIG. 1. The computation device 20 includes an input unit 21, a storage unit 22 (storage), a display unit 23, and a control unit 24 (controller).

The input unit 21 includes an input interface that can accept a signal output by the force detection device 10. The input unit 21 is electrically connected to the force detection device 10. The input unit 21 accepts input of the signals output by the plurality of force sensors 11.

The storage unit 22 is, for example, a semiconductor memory, a magnetic memory, or an optical memory but is not limited thereto. The storage unit 22 may function as, for example, a main storage device, an auxiliary storage device, or a cache memory. The storage unit 22 stores any information used in an operation of the computation device 20. For example, the storage unit 22 may store various information and the like such as a system program and an application program.

The storage unit 22 stores the calibration value calculated based on the force applied in advance to the force detection device 10. Details of the calibration value stored in the storage unit 22 will be given below.

The display unit 23 displays various information. The display unit 23 may be, for example, a liquid-crystal display. The display unit 23 is not limited to a liquid-crystal display and may be, for example, an organic EL (electroluminescent) display.

The control unit 24 includes at least one processor, at least one dedicated circuit, or a combination thereof. The processor is a general-purpose processor such as a CPU (central processing unit) or a GPU (graphics processing unit) or a dedicated processor specialized for a specific process. The dedicated circuit is, for example, an FPGA (field-programmable gate array) or an ASIC (application-specific integrated circuit). The control unit 24 executes a process relating to an operation of the computation device 20 while controlling each unit of the computation device 20.

### (Calibration of Force Detection System)

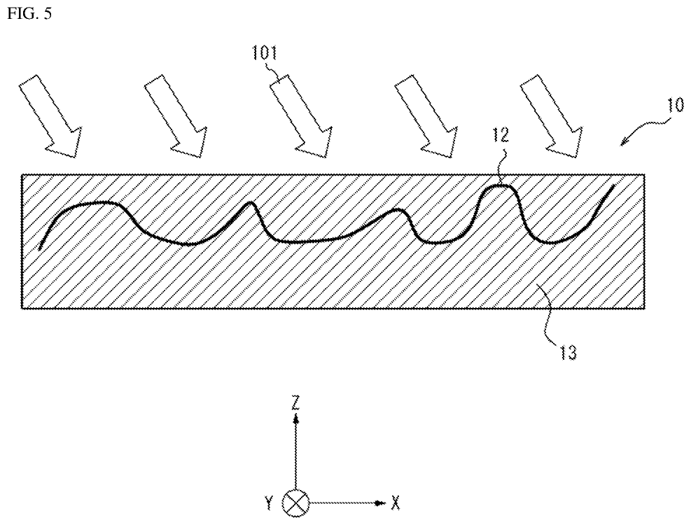

Calibration of the force detection system 1 is described with reference to FIG. 5 and the like. In the force detection device 10, the substrate 12 is fixed in the folded state by the fixing member 13. How the substrate 12 is folded and fixed by the fixing member 13 differs according to the individual force detection device 10. As such, what kind of outputting is performed by the force detection device 10 when a certain force is applied differs according to the individual force detection device 10.

Therefore, in the force detection system 1, the force detection device 10 is calibrated in advance, and the calculated calibration value is stored in the storage unit 22 of the computation device 20.

FIG. 5 illustrates one example of a force 101 being applied to the force detection device 10 for calibration. As illustrated in FIG. 5, when calibrating the force detection device 10, a force 101 of a specific magnitude and orientation distribution is applied to the force detection device 10.

The control unit 24 of the computation device 20 associates an output of the force detection device 10, from when the force 101 of the specific magnitude and orientation distribution is applied, with the magnitude and orientation distribution of the force 101 and stores these in the storage unit 22. Forces 101 of various magnitude and orientation distributions are applied to the force detection device 10. For each force 101 of these magnitude and orientation distributions, the control unit 24 of the computation device 20 associates the output of the force detection device 10 with the magnitude and orientation distribution of the force 101 and stores these in the storage unit 22.

The control unit 24 calculates the calibration value based on a plurality of data, stored in the storage unit 22, associating the output of the force detection device 10 and the magnitude and orientation distribution of the force 101. The control unit 24 may calculate the calibration value by, for example, performing machine learning or multivariate analysis. The control unit 24 stores the calculated calibration value in the storage unit 22.

### (Measurement of Force Applied to Force Detection Device)

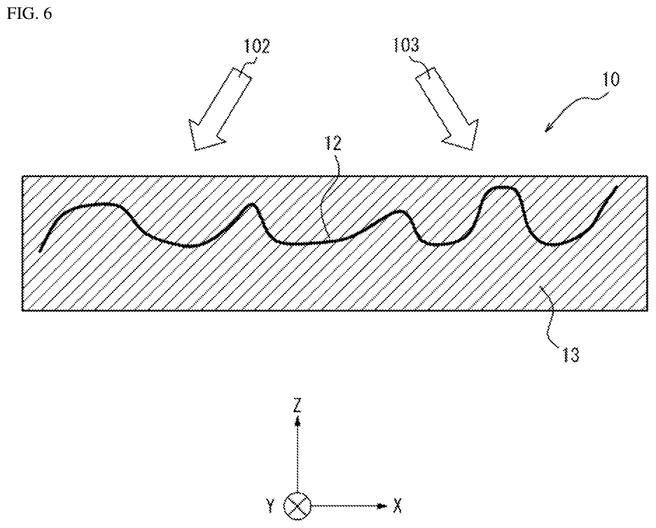

FIG. 6 illustrates a force detection device 10 for which the calibration value is already calculated detecting a force 102 and a force 103 that are applied.

When the force 102 and the force 103 are applied thereto, the force detection device 10 outputs a signal corresponding to the applied force.

The control unit 24 of the computation device 20, upon acquiring the signal output by the force detection device 10, calculates the force applied to the force detection device 10 based on the acquired signal and the calibration value for the force detection device 10 stored in the storage unit 22.

Because the force detection device 10 includes the plurality of force sensors 11 oriented in the plurality of three-dimensional directions, the control unit 24 of the computation device 20 can calculate a magnitude and orientation distribution of the force applied to the force detection device 10.

The control unit 24 may store the calculated magnitude and orientation distribution of the force applied to the force detection device 10 in the storage unit 22. Alternatively, the control unit 24 may display the calculated magnitude and orientation distribution of the force applied to the force detection device 10 on the display unit 23.

### (Manufacturing Method of Force Detection Device)

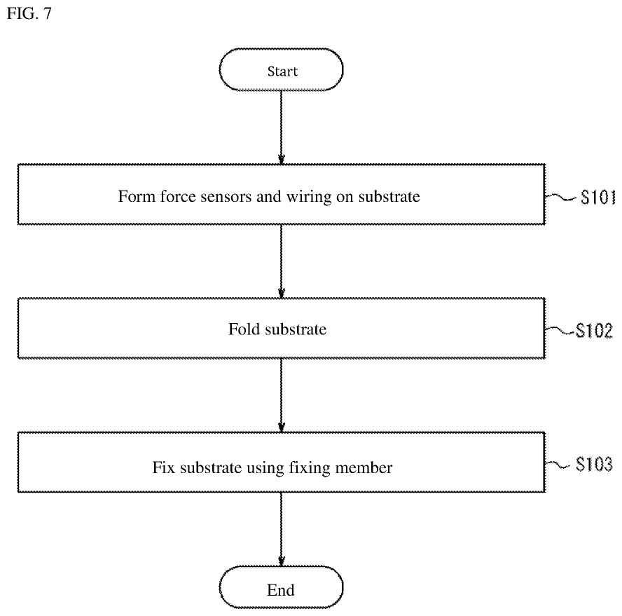

Next, one example of a manufacturing method of the force detection device 10 is described with reference to the flowchart illustrated in FIG. 7.

At step S101, the plurality of force sensors 11 and the wiring 14 are formed on the substrate 12.

At step S102, the substrate 12 is folded. The substrate 12 may be folded randomly or folded regularly.

At step S103, the substrate 12 in the folded state is fixed by the fixing member 13. Note that the substrate 12 may be placed inside the fixing member 13 in the folded state and thereafter be fixed by the fixing member 13 or be folded upon being placed in the fixing member 13 and thereafter be fixed by the fixing member 13.

In a force detection device 10 according to one or more embodiments such as that above, the plurality of force sensors 11 is formed on the substrate 12. Moreover, the fixing member 13 fixes the substrate 12 in the folded state. In this manner, by the substrate 12 whereon the plurality of force sensors 11 is formed being fixed by the fixing member 13 in the folded state, the plurality of force sensors 11 is oriented in a plurality of three-dimensional directions. As such, the force detection device 10 can detect a force in a triaxial direction even if individual force sensors 11 can only detect forces in one direction. Therefore, the force detection device 10 according to one or more embodiments can detect a force in a triaxial direction by a simple structure such as this.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

For example, arrangements, item counts, and the like of each component above are not limited to the description above and the content illustrated in the drawings. The arrangements, item counts, and the like of each component may be configured in any manner as long as the functions thereof can be realized.

Furthermore, although description in the present disclosure is centered around a device, the present disclosure can also be realized as a method including steps executed by each component of the device, a method executed by a processor provided in the device, a program, or a storage medium recording a program. It should be understood that the scope of the present disclosure also includes such.

For example, in the above embodiment, the plurality of force sensors 11 is arranged in a matrix on the substrate 12. However, the arrangement of the plurality of force sensors 11 on the substrate 12 is not limited thereto. The plurality of force sensors 11 may be formed on the substrate 12 in any arrangement. When the arrangement of the plurality of force sensors 11 on the substrate 12 in the state prior to folding is made to be a regular arrangement in a matrix, the plurality of force sensors 11 can be formed in a high density on the substrate 12. As such, the force detection device 10 can detect the applied force at a high spatial resolution.

For example, in the above embodiment, the wiring 14 connects the plurality of force sensors 11, arranged on the substrate 12, in a matrix. However, the wiring 14 may be connected to the plurality of force sensors 11 in any connection form as long as signals can be extracted from the plurality of force sensors 11. For example, a configuration may be such that each force sensor 11 is connected to two lines of wiring 14 dedicated to this force sensor 11. When the wiring 14 connects the plurality of force sensors 11, arranged on the substrate 12, in a matrix, the wire count of the wiring 14 can be decreased. As a result, the force detection device 10 can be reduced in size.

For example, although the above embodiment describes calibration of the force detection device 10, it is not essential to calibrate the force detection device 10. For example, when the substrate 12 is folded in a predetermined shape that is prescribed in advance, it is sufficient to store a theoretical value, a simulation value, or the like calculated for the predetermined shape prescribed in advance in the storage unit 22, without performing calibration.

For example, in the above embodiment, the plurality of force sensors 11 is formed on the substrate 12. However, the plurality of force sensors 11 does not necessarily need to be formed on the substrate 12. It is sufficient for the plurality of force sensors 11 to be arranged two-dimensionally and to be electrically connected by the wiring 14.

For example, in the above embodiment, the substrate 12 is described as being a tabular substrate. However, the substrate 12 may be in the shape of a net or the like.
1 Force detection system
10 Force detection device
11 Force sensor
12 Substrate
13 Fixing member
14 Wiring
14A Vertical wiring
14B Horizontal wiring
20 Computation device
21 Input unit
22 Storage unit
23 Display unit
24 Control unit

What is claimed is:

1. A force detection device, comprising:
a substrate;
a plurality of force sensors disposed on the substrate; and
a fixing member that fixes the substrate therein in a folded state.

2. The force detection device according to claim 1, wherein the fixing member fixes the substrate in a randomly folded state.

3. The force detection device according to claim 1, wherein the fixing member fixes the substrate in a regularly folded state.

4. The force detection device according to claim 1, wherein the plurality of force sensors is formed on the substrate by being distributed two-dimensionally thereon.

5. The force detection device according to claim 1, wherein the substrate is a flexible substrate.

6. The force detection device according to claim 1, wherein the fixing member is a resin.

7. A force detection system, comprising:
a force detection device that comprises:
a substrate;
a plurality of force sensors formed on the substrate; and
a fixing member that fixes the substrate therein in a folded state; and
a computation device that comprises:
a storage that stores a calibration value calculated based on a force applied in advance to the force detection device; and
a controller that, based on the calibration value, calculates a force applied to the force detection device.

8. The force detection system according to claim 7, wherein the fixing member fixes the substrate in a randomly folded state.

9. The force detection system according to claim 7, wherein the fixing member fixes the substrate in a regularly folded state.

10. The force detection system according to claim 7, wherein the plurality of force sensors is formed on the substrate by being distributed two-dimensionally thereon.

11. The force detection system according to claim 7, wherein the substrate is a flexible substrate.

12. The force detection system according to claim 7, wherein the fixing member is a resin.

13. A manufacturing method of a force detection device, comprising:
forming a plurality of force sensors on a substrate;
folding the substrate; and
fixing the substrate in a folded state by a fixing member.
